(19) United States
(12) Patent Application Publication
(10) Pub. No.: US 2019/0378224 A1
(43) Pub. Date: Dec. 12, 2019

(54) BLOCKCHAIN-BASED DISTRIBUTION PLATFORM

(71) Applicant: Walter Krych, Sheffield Village, OH (US)

(72) Inventor: Walter Krych, Sheffield Village, OH (US)

(21) Appl. No.: 16/438,445

(22) Filed: Jun. 11, 2019

Related U.S. Application Data
(60) Provisional application No. 62/683,391, filed on Jun. 11, 2018.

(51) Int. Cl. G06Q 50/14; G06Q 20/36; G06Q 10/02; G06Q 20/38

(52) U.S. Cl. CPC G06Q 50/14; G06Q 20/389; G06Q 10/02; G06Q 20/3678

(57) ABSTRACT

One or more techniques and/or systems are disclosed for mitigating distribution costs for travel providers while allowing customers to buy, sell, and view available travel reservations on a de-centralized GDS/PMS/OTA network driven by Blockchain technology. Further, the system can allow for customer-to-customer sales of travel reservations using the de-centralized GDS/PMS/OTA solution.

### CROSS-REFERENCE TO RELATED APPLICATIONS

This application claims priority to U.S. Provisional Patent Application Ser. No. 62/683,391, entitled BLOCKCHAIN-BASED DISTRIBUTION PLATFORM, filed Jun. 11, 2018; which is incorporated herein by reference.

### BACKGROUND

Travel providers sell their services through a process that includes multiple distribution intermediaries. Intermediaries may include Online Travel Agencies (OTAs), Airline Reporting Corporations (ARCs), Billing and Settlement Plans (BSPs), Global Distribution Systems (GDSs), Property Management Systems (PMSs), and credit card processing systems, for example. These intermediaries help aggregate inventory of the available services (i.e., airline seats, hotel rooms, cruise cabins, rental cars, insurance, etc.) and allow consumers to view and purchase these services from the travel providers.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The present application discloses a GDS/PMS/OTA (Global Distribution System/Property Management System and On-line Travel Agency) SaaS (Software as a Service) blockchain-based distribution platform for the travel industry. The current GDS/PMS/OTA systems offered are outdated, inefficient, centralized, and not competitive, and the present application discloses methods and systems to improve the current systems.

The innovative concept described in the present application utilizes Blockchain technology to mitigate or eliminate distribution fees associated with the current structure of Global Distribution Systems. Through the system described herein, customers may purchase services through typical Online Travel Agencies or through a Blockchain-driven GDS/PMS/OTA platform. The platform described in the present application will provide a more efficient and less expensive way for travel providers to sell their services and for customers to purchase the services.

One or more techniques and/or systems are disclosed for mitigating distribution costs for travel providers while allowing customers to buy, sell, and view available travel reservations on a de-centralized GDS/PMS/OTA network driven by Blockchain technology. Further, the system can allow for customer-to-customer sales of travel reservations using the de-centralized GDS/PMS/OTA solution.

In an exemplary method, a customer may search an OTA for available seats on an airline flight. The results may list available flights and seats on those flights. If the flight has not been scheduled, the flight will be listed as “open” and the customer may select his or her preference for flight times. Once a flight time is selected, the flight will be listed as “scheduled.” For a scheduled flight, a user may purchase seats on the flight, but may not change the flight time.

In another exemplary method, to purchase an airline ticket, a user may select a flight option from an OTA interface. After the flight option is selected, the user may use a credit card to load a virtual and reloadable wallet. The virtual wallet may hold a virtual currency, such as a cryptocurrency. The virtual currency will be transferred from the customer's wallet to a virtual wallet associated with a travel provider (such as an airline company). At the same time, the airline reservation (i.e., ticket, etc.) will be transferred to the virtual wallet of the customer. The transaction process is maintained and completed using a Blockchain technology. The transaction uses a blockchain to create a smart contract associated with the transaction. This smart contract can be accessed by a travel provider or may be accessed through a backup system, for emergencies.

In another exemplary method, customers may sell their airline reservations on a peer-to-peer (P2P) network. The P2P network transactions are facilitated using Blockchain technology and a cryptocurrency. A customer may decide to sell his or her travel reservation/ticket for a greater value than the original purchase price. When a customer decides to sell the ticket, the reservation information associated with the ticket will appear on the system's OTA for other customers to purchase. Upon the sale of a ticket, the virtual currency from the purchasing customer will transfer to the virtual wallet of the seller. The reservation/ticket will transfer from the seller's virtual wallet to the purchasing customer's virtual wallet. When the sale is complete, a smart contract will be created/updated, and the travel provider will be able to access the new travel details.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### BRIEF DESCRIPTION OF THE DRAWINGS

FIG. 1 is a diagram showing the system 100, as described herein.

FIG. 2 is another diagram showing an exemplary embodiment of the system shown in FIG. 1.

FIG. 3A is a detailed diagram showing the GDS/PMS/OTA system 102, as described herein.

FIG. 3B is a detailed diagram showing the customer device 104, as described herein.

FIG. 4 is a diagram comparing the current state of technology to the system 100, as described herein.

FIG. 5 is another diagram showing the current state of technology, as described herein.

FIG. 6 is a block diagram showing an exemplary method, as described herein.

FIG. 7 shows additional features of the exemplary method, as described herein.

FIG. 8 shows additional features of the exemplary method, as described herein.

FIG. 9 shows additional features of the exemplary method, as described herein.

FIG. 10 shows additional features of the exemplary method, as described herein.

FIG. 11 shows additional features of the exemplary method, as described herein.

FIG. 12 shows features of the marketplace platform, as described herein.

FIG. 13 shows additional features of the exemplary method, as described herein.

FIG. 14 shows additional features of the exemplary method, as described herein.

FIG. 15 shows additional features of the exemplary method, as described herein.

FIG. 16 shows additional features of the exemplary method, as described herein.

FIG. 17 shows additional features of the exemplary method, as described herein.

FIG. 18 shows an exemplary financial analysis of the present innovative concept.

FIG. 19 shows an exemplary financial analysis of the present innovative concept.

FIG. 20 shows an exemplary financial analysis of the present innovative concept.

FIG. 21 shows an exemplary financial analysis of the present innovative concept.

FIG. 22 shows an exemplary process flow chart for the process described herein.

FIGS. 23-30 show an exemplary user interface for the marketplace platform described herein.

FIGS. 31-35 show an exemplary user interface for a GDS/OTA solution utilizing Blockchain technology as described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The current process of using multiple distribution intermediaries leads to issues of double marginalization and inflated prices for customers. In addition, the current fee structure of GDS solutions makes it difficult for small to mid-size travel providers to earn a profit selling their services. Specifically, current GDS solutions require large up-front service costs as well as large per-transaction costs associated with sales. The innovative concept described in the present application utilizes Blockchain technology to mitigate or eliminate distribution fees associated with the current structure of Global Distribution Systems. Through the system described herein, customers may purchase services through typical Online Travel Agencies or through a Blockchain-driven GDS/PMS/OTA platform. The platform described in the present application will provide a more efficient and less expensive way for travel providers to sell their services and for customers to purchase the services.

The current GDS platforms are inefficient, outdated, expensive, and do not allow for growth. There has been no evolution in the market for the last fifty years (other than to user interface or OTA technology). The current system does not prevent against issues such as double booking, and since the current system is centralized, it is prone to security threats and system crashes. Intermediaries that act as arbiters of the money and information may operate on a thirty to sixty day billing and settlement structure. The current fees associated with distribution services may range from 8% to 30% of gross revenue. These fees are not negotiable and is set to the particular segment the supplier serves. The fees may hinder growth and make entrance into the market difficult for small to mid-size travel providers. The present innovative concept aims to resolve the inefficiencies of the current system to provide a more streamlined approach using a Blockchain-driven GDS/OTA platform.

The present innovative concept may provide benefit to airline travel providers, for example in Part 135 and Part 121 operations. Part 135 governs the rules and regulations associated with commuter and on-demand operations. This includes most corporate, government, and helicopter operations. Commuter operations deal with small-scale aircraft that operate on a scheduled operation of at least “five round trips per week on at least one route between two or more points according to the published flight schedule.” Commuter operations apply to airplanes carrying nine or fewer passengers. On-demand operations deal with flights that do not operate on a set schedule and that are driven by request of the customer.

Part 135 operations personnel currently fill empty legs of flights to optimize their fleet profitability. However, these reservations are not done through a GDS/OTA method, as described in the present application.

Part 121 governs the rules and regulations associated with large-scale regional and other major airlines (e.g., United Airlines, Delta Airlines, Southwest Airlines, etc.).

Blockchain is a widely distributed database system that is validated by a wider community, rather than a central authority. It is a collection of records that a distributed network maintains, rather than relying on a single entity, like a bank or government, which most likely hosts data on a particular server, utilizing computers, and the internet. Each “block” in a chain represents a number of some number of records, and the “chain” component links them all together with a hash function. As records are created, they are confirmed by a distributed network of computers and paired up with the previous entry in the chain, thereby creating a chain of blocks, or a blockchain.

It is a continuously growing list of records, called blocks, which are linked and secured using cryptography. Each block typically contains a cryptographic hash of the previous block, a timestamp, and transaction data. By design, a blockchain is resistant to modification of the data, and is “an open, distributed ledger that can record transactions between two parties efficiently and in a verifiable and permanent way”. For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority.

Blockchains are secure by design and exemplify a distributed computing system with high Byzantine fault tolerance. Decentralized consensus has therefore been achieved with a blockchain. This makes blockchains potentially suitable for the recording of events, medical records, and other records management activities, such as identity management, transaction processing, documenting provenance, food traceability, and voting.

Blockchain was invented by Satoshi Nakamoto in 2008 to serve as the public transaction ledger of the cryptocurrency bitcoin. The innovative concept of the blockchain for bitcoin made it the first digital currency to solve the double-spending problem without the need of a trusted authority or central server. The bitcoin design has inspired other applications.

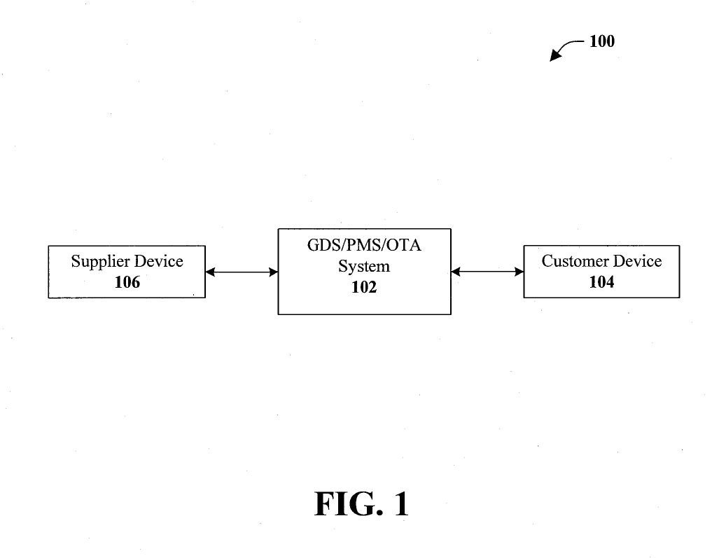

FIG. 1 shows an exemplary GDS/PMS/OTA system that uses Blockchain technology to provide travel services at little or no cost to travel providers. It may allow customers to easily buy, sell, and view available travel services on a de-centralized GDS/PMS/OTA network driven by Blockchain technology. This system may operate as a peer-to-peer (P2P) network allowing customers to buy and sell travel services from each other rather than purchasing from a travel provider. The system provided in the present application may also integrate with existing OTA platforms (e.g., Travelocity, Expedia, Hotels.com, TripAdvisor, Orbitz, etc.) to allow customers to purchase travel services in the typical manner (e.g., online through Expedia using a credit card, etc.). Said differently, the system described herein may utilize an internal OTA feature or may integrate with customer devices such as existing OTA platforms described above. In either manner, the travel providers will be able to post their travel services for little or no distribution cost. The DGS/PMS/OTA system described herein may allow every Part 121 or Part 135 air-carrier to enter the market and earn a profit. This may be done by eliminating high-cost fees associated with current GDS/PMS/OTA platform and by utilizing a de-centralized DGS/PMS system with Blockchain technology.

The supplier device 106 may represent a device at a travel provider (e.g., airline, rental car company, hotel, cruise ship, resort, etc.). The supplier device may interact with the GDS/PMS/OTA system 102 to share travel information. The GDS/PMS/OTA system 102 may act as a de-centralized system that aggregates and transmits information regarding travel services from one or more supplier devices to one or more customer devices. Information for an airline, for example, may include the airline's current inventory, available seats, current costs, travel times, travel dates, airline, airport information, and the like.

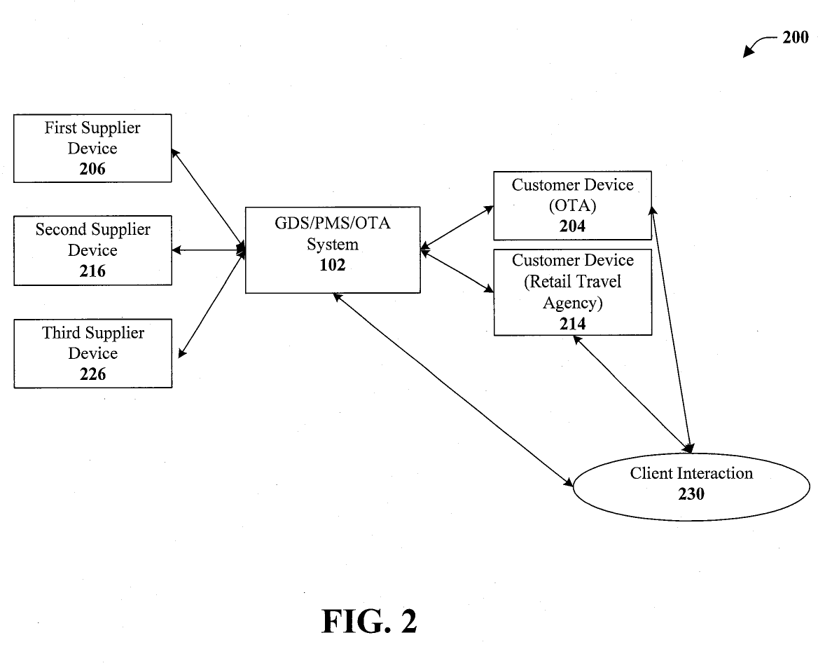

FIG. 2 show an exemplary system 200 with a number of supplier devices 206, 216, 216. The system 200 may include any number of supplier devices. The system 200 also shows multiple customer devices 204, 214. By way of example customer device 204 may be associated with an OTA platform, and customer device 214 may be associated with a retail travel agency platform. Clients may interact with the system by interaction with the OTA 204, through interaction with a travel agency 214, through direction interaction with the system 102, or any number of similar manners.

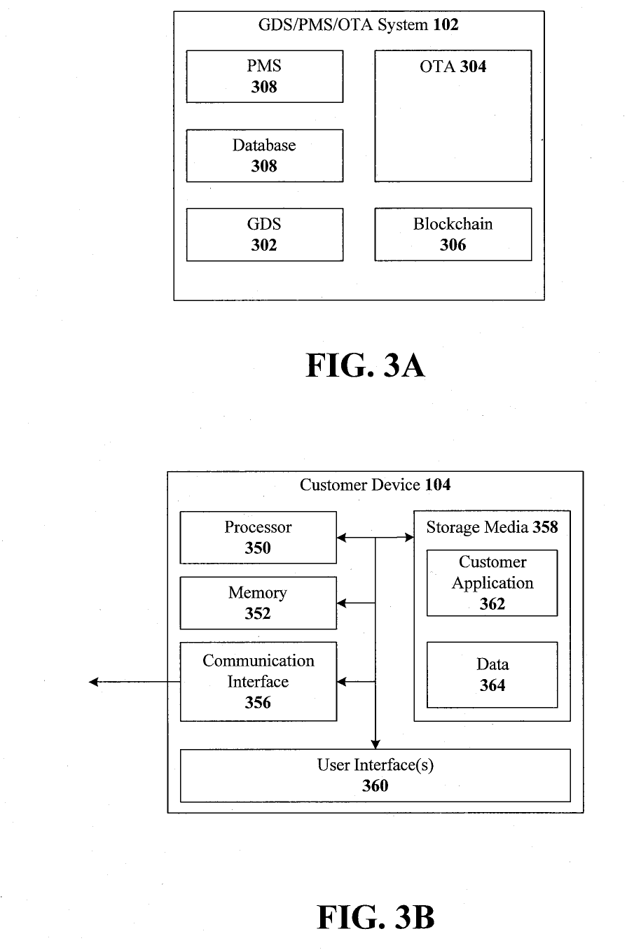

Turning to FIG. 3A, the GDS/PMS/OTA system 102 is described in greater detail. The GDS/PMS/OTA system 102 is a de-centralized system that enables transactions between suppliers (e.g., airlines, hotels, rental car companies, etc.) and customers (individuals or travel agencies, both online and in-person). A GDS/PMS network may hold no inventory, but rather may utilize real-time links to supplier databases that hold information relating to travel inventory. The present innovative concept aims to utilize Blockchain technology in the GDS/PMS/OTA system 102 to allow suppliers to sell travel services directly to customers without distribution fees and without having to go through excess intermediaries (e.g., Airline Reporting Corporations (ARCs), Billing and Settlement Plans (BSPs), Global Distribution Systems (GDSs), Property Management Systems (PMSs), and credit card processing systems, etc.).

FIG. 3B illustrates a schematic block diagram of an exemplary, non-limiting embodiment of customer device 104. Customer device 104 includes one or more processor(s) 350 configured to execute computer-executable instructions such as instructions composing a customer application 362. Such computer-executable instructions can be stored on one or more computer-readable media including non-transitory, computer-readable storage media such as memory 352 or storage 358. For instance, storage 358 can include non-volatile storage to persistently store customer application 362 and/or data 364. Memory 352 can also include volatile storage that stores instructions, other data (working data or variables), or portions thereof during execution of client application 362 by processor 350. Customer application 362 may be a web browser application or a native application configured to access the product discovery portal 100 via an API.

Customer device 104 further includes a communication interface 356 to couple customer device 104, via the Internet or other communications network, to the GDS/PMS/OTA system 100. Communication interface 356 can be a wired or wireless interface including, but not limited, a WiFi interface, an Ethernet interface, a Bluetooth interface, a fiber optic interface, a cellular radio interface, a satellite interface, etc. Customer device 104 can further include a user interface 360 that comprises various elements to obtain user input and to convey user output. For instance, user interface 360 can comprise of a touch display, which operates as both an input device and an output device. In addition, user interface 360 can also include various buttons, switches, keys, etc. by which a user can input information to customer device 104; and other displays, LED indicators, etc. by which other information can be output to the user. Further still, user interface 360 can include input devices such as keyboards, pointing devices, and standalone displays.

In accordance with an embodiment, customer device 104 is a computing device, which is readily carried by a user, such a smartphone or tablet device. However, it is to be appreciated that customer device 104 can be other portable form-factors such as a laptop computer, a convertible laptop, a watch computing device, or the like. Moreover, customer device 104 can be a desktop computer, or other larger, less portable computing device. That is, client application 362 can be installed and executed on substantially any computing device provided that such a computing device can communicate with the GDS/PMS/OTA system 100 as described herein.

The client application 362 configures the customer device 104 to receive information from the GDS/PMS/OTA system 100 such as user prompts, commands, search queries, or other travel information (e.g., inventory, flight number, date, available seats, prices, yield management parameters, refund rules, etc.).

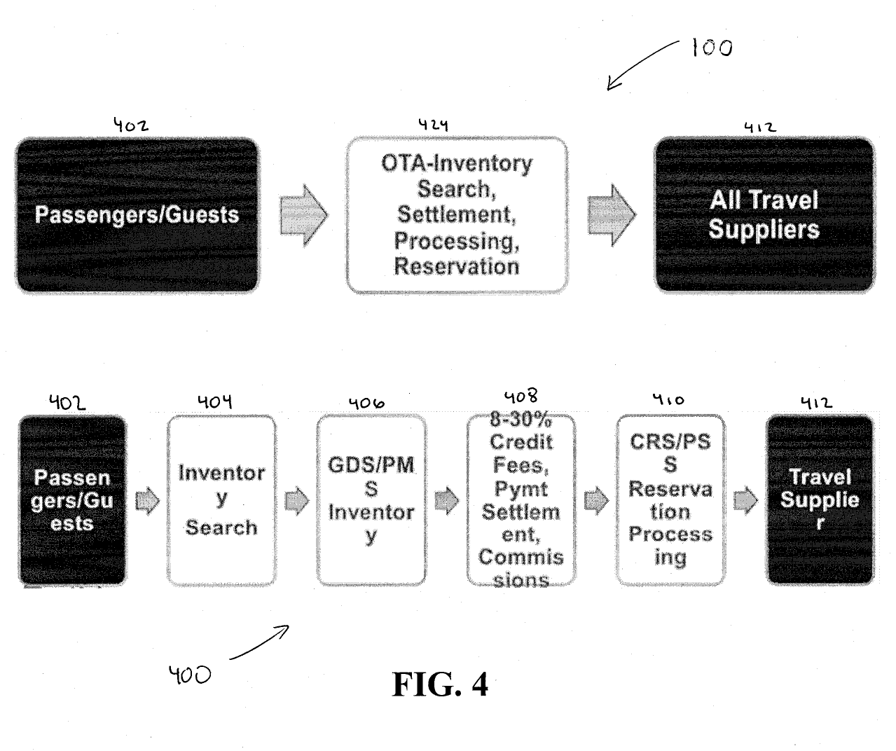

FIG. 4 shows an example block diagram comparing the current state 400 of technology to the system 100 described in the present application. In an example, the current state of GDS/PMS technology delivers information on travel services/reservations from travel suppliers (travel providers) 412 to passengers/guests (customers) 402. The process involves a number of intermediaries acting between the passengers 402 and the travel suppliers 412. By way of example, the intermediaries may include inventory-searching platforms 404, GDS/PMS inventory platforms 406, credit fees/commission/settlement platforms 408, and CRS/PSS reservation platforms 410.

As described in the present application, the system 100 may bridge the gap between passengers 402 and travel supplies 412 by providing a single system 424. The system 424 may handle all functions handled by intermediaries 404, 406, 408, 410, and others, for little or no cost to the travel suppliers 412. Functions of the system 424 may include OTA functionality, inventory searching, settlement processing, reservations, for example.

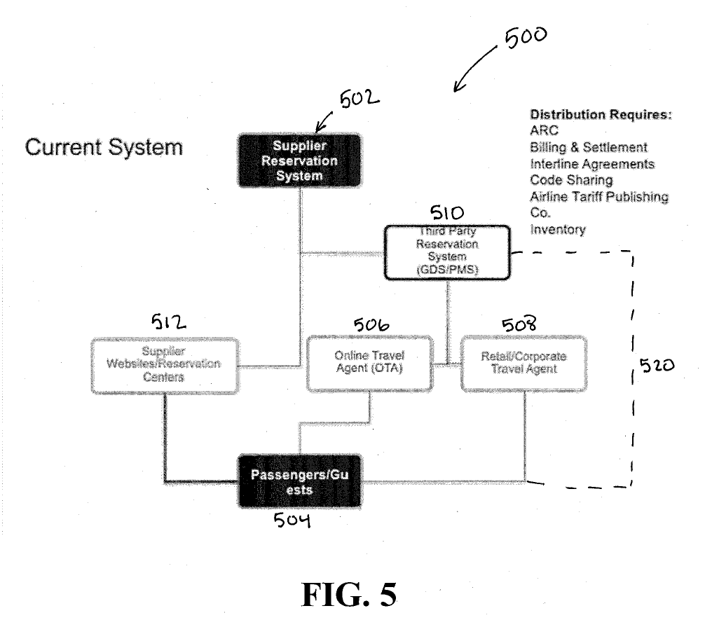

FIG. 5 shows the distribution of information between various components of a travel services network 500. The network 500 may facilitate interaction between customers, passengers, or guests shown at block 504 to the travel provider/travel supplier reservation system 502. As shown in FIG. 5, customers may interact with the supplier reservation system using at least three different methods. The first is through a supplier website/reservation center 512. The supplier website 512 serves as the only intermediary between the customers 504 and the supplier reservation system 502. The second and third methods, online travel agents 506 and retail/corporate travel agents 508, require a third party reservation system (GDS/PMS) 510. The GDS/PMS system 510 serves as an intermediary between the supplier reservation system 502 and the customers 504.

The present application describes a system 100 that replaces the current GDS/PMS system 510. The system 100 may perform all the functions of the current GDS/PMS system 510 with little to no cost to travel providers. The system 100 described herein may be fully integrated with the current system and my handle interactions between the online travel agent 506 and the retail/corporate travel agent 508. Additionally, the system 100 may provide for direct interaction between the customers 504 and the supplier reservation system 502, as shown by the line 520. The system 100 may allow a customer 504 to interact directly with the supplier reservation system 502 through the use of Blockchain technology. These interactions may include direct access to the travel provider/supplier's current inventory, available flights, seats, costs, airports, travel times, etc. and may allow the customer 504 to purchase directly from the travel supplier/provider. The customers may interact with the online travel agent 506, as done currently, or may interact directly through system 100's GDS/PMS/OTA system 102. As discussed previously, the GDS/PMS/OTA system 102 may include an OTA device 304 that may facilitate direct transactions between the customers 504 and the travel suppliers 502 using Blockchain technology.

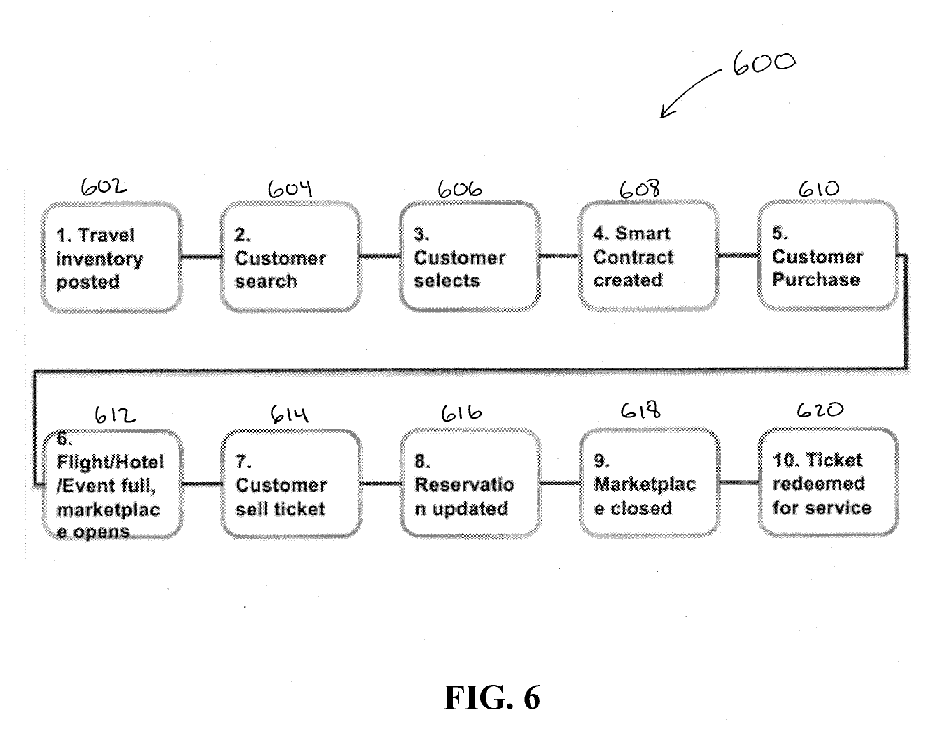

FIG. 6 shows an exemplary method 600 for the purchase of a travel service/reservation by a customer from a travel provider. The process 600 may include steps such as posting the travel inventory 602, customer search 604, a customer selection 606, creating a smart contract 608, customer purchase 610, marketplace opening 612, customer sale of ticket 614, updated reservation 616, marketplace closing 618, and redemption of the ticket for service 620. In another exemplary method, the steps marketplace opening 612, customer sale of ticket 614, updated reservation 616, and marketplace closing 618, are not needed for the purchase of a travel service. It should also be recognized that that the process 600 may be accomplished with additional steps, fewer steps than shown, or any other combination of steps. Each step is described in further detail below.

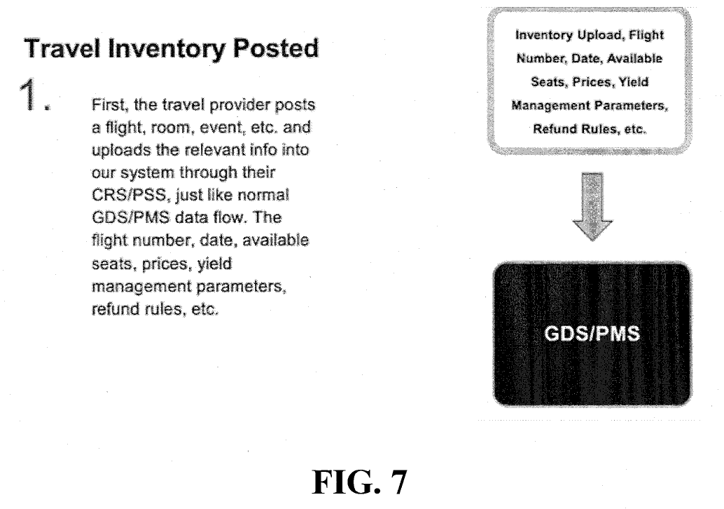

FIG. 7 provides additional information regarding step 602 of process 600. Specifically, in step 602, the travel service provider may provide details about a service (e.g., flight, hotel room, event, rental car, cruise, etc.) to the system 100. This can be done through the travel provider's CRS/PSS as done in normal GDS/PMS data systems. The data provided to the system 100 may include information such as flight number, date, time, available seats, prices, yield management parameters, refund rules, etc.

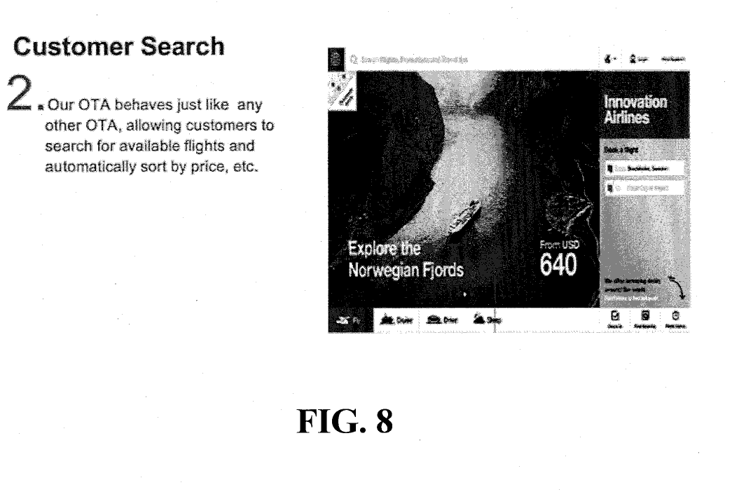

FIG. 8 provides additional information regarding step 604 of the process 600. Specifically, in step 604 a customer may search the information provided in step 602. The OTA 304 of the system 102 can operate in a similar manner to the OTA 506 (i.e., existing OTAs such as Expedia, Orbitz, etc.). The OTA 304, however, is integrated into the system 102 to provide a seamless interaction with the supplier reservation system 502 for the customer. The OTA 304 allows for a customer to read data and information directly from the supplier reservation system 502 to make purchases, for example. The OTA 304 may include conventional searching and sorting tools to better assist a customer in searching. For example, the customer may search my date, time, price, airport, etc.

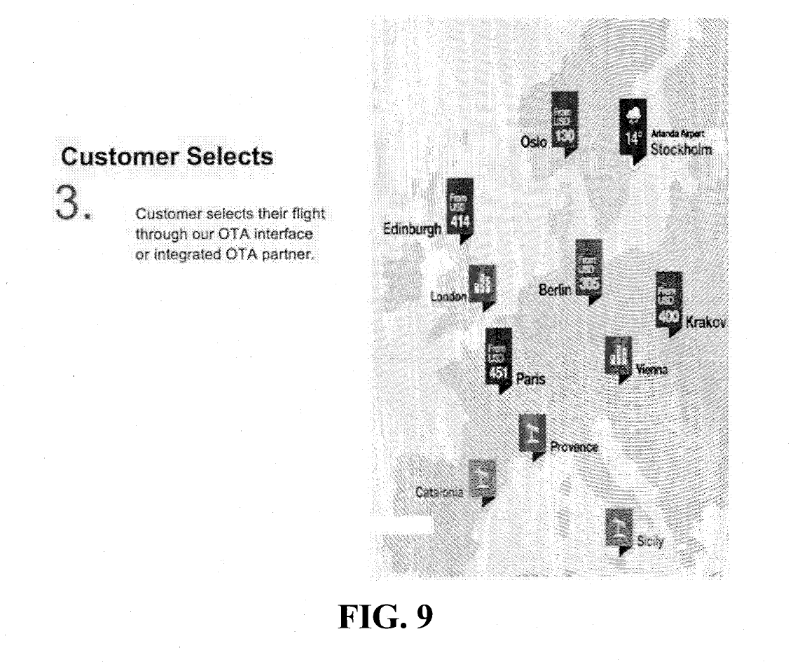

FIG. 9 provides additional information regarding step 606 of the process 600. In step 606 the customer selects a travel service through the OTA interface 304. Alternatively, the customer may select a travel service through the OTA interface 506 representing an integrated OTA. In one example the travel service is a flight option, however, any number of services may be selected (e.g., hotel room, rental car, cruise, event, etc.).

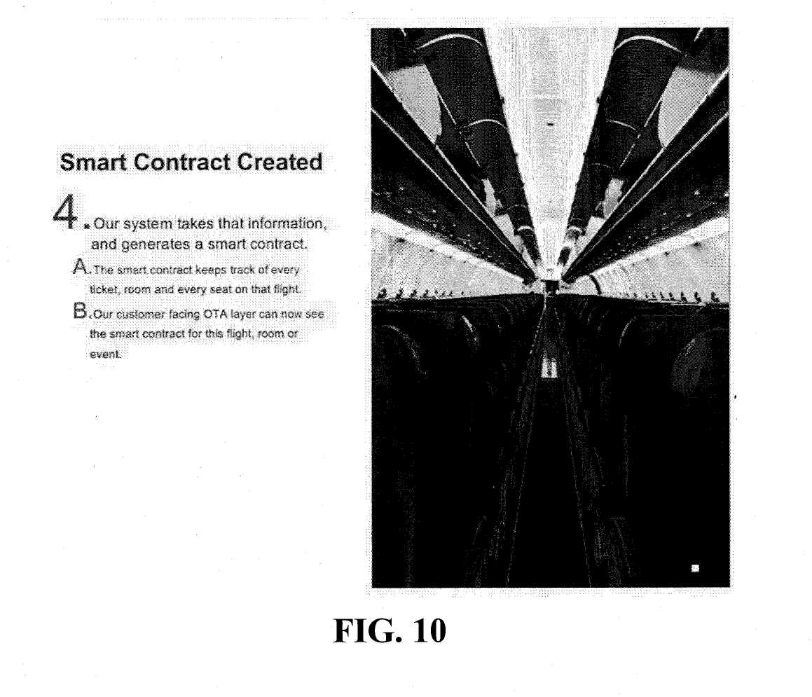

FIG. 10 provides additional information regarding step 608 of the process 600. In step 608, a smart contract is created using the selection criteria and information from the previous steps. A smart contract is a computer protocol that can facilitate the performance of, verify, and enforce a contract without the need of a third party intermediary. The smart contract keeps track of each ticket, room, seat, etc. on a flight, for example. Further, the customer-facing OTA layer can view the smart contract created for each flight.

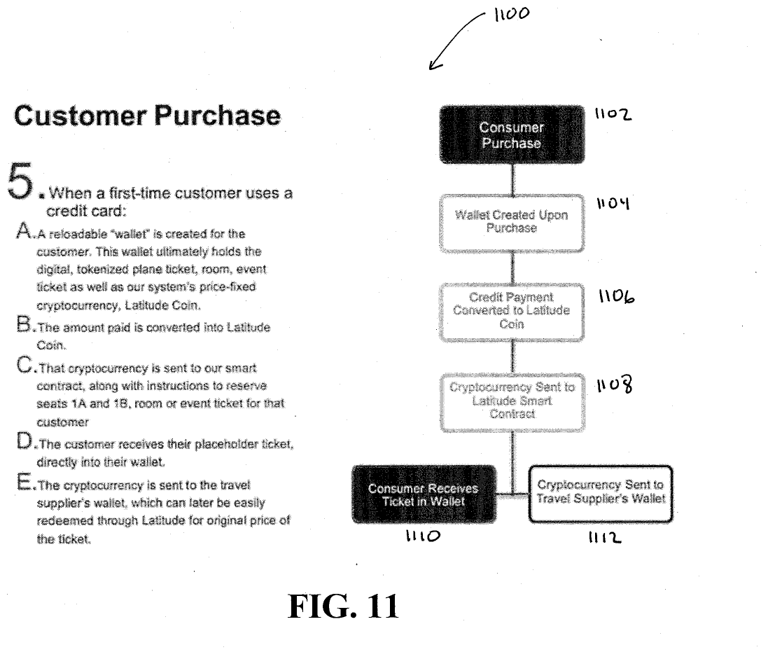

FIG. 11 provides additional information regarding step 610 of the process 600. In step 610, the customer purchases a service provided by at least one travel provider. In an example, a customer may purchase an airline ticket from a regional airline, shown as block 1102. A customer may use a credit card for the purchase of the service. When a first-time user uses a credit card for the purchase, a reloadable wallet is created for the user, shown as block 1104. The wallet serves as the holder of the digital data associated with the transaction and smart contract (e.g., tokenized plane ticket, event ticket, cryptocurrency, etc.). To perform the transaction, the amount paid via the customer's credit card may be converted to a value in cryptocurrency, shown as block 1106. In an example embodiment, the cryptocurrency may be Latitude Coin. In another example, the cryptocurrency may be Bitcoin, Tether, Ethereum, Ripple, or any other equivalent.

After the value paid by credit card is converted to a cryptocurrency such as Latitude Coin, the cryptocurrency is sent to the smart contract associated with the sale of the travel service, shown as block 1108. In addition to the currency, the system also sends purchase instructions to the smart contract to perform the order. These instructions, for example, may include a request to reserve seat 1A on a specific flight. In another example, the instructions may be to reserve two rooms at a specific hotel. It should be appreciated that reservation instructions may be specifically tailored for each individual purchase of any travel service.

After the cryptocurrency and the reservation instructions are sent to the smart contract, the service (e.g., airline ticket, hotel reservation, event ticket, etc.) is delivered directly to the customer's wallet, shown as block 1110. At the same time, the service is delivered to the customer, the cryptocurrency is sent to the travel provider's wallet, shown as 1112. Cryptocurrency that is in a user's wallet may be converted from the current cryptocurrency to any other form of currency (e.g., U.S. dollars, etc.).

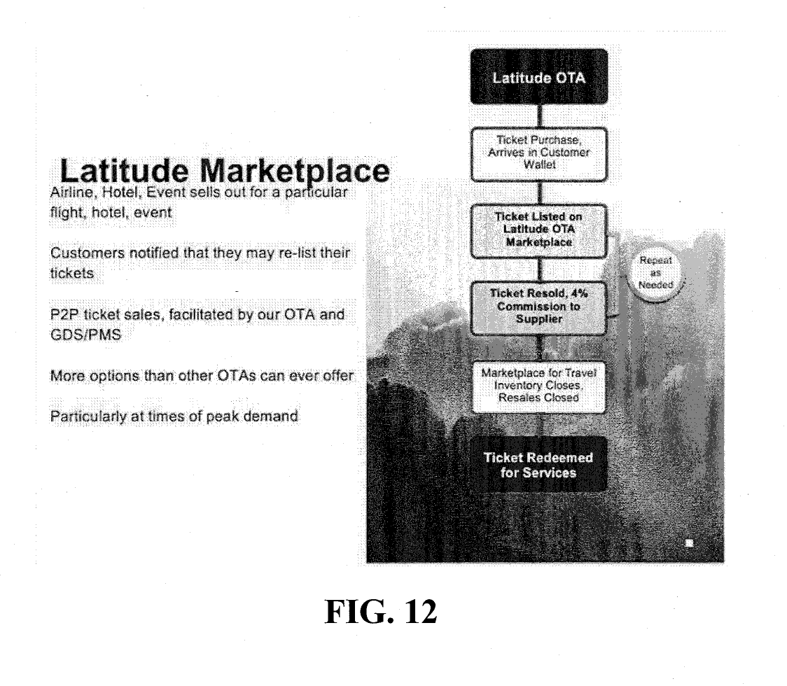

FIGS. 12-16 illustrate the marketplace functionality of the system 100. The marketplace functionality allows customers to sell their purchased services (e.g., airline ticket, hotel room reservation, event ticket, etc.) directly to other customers. The purchase and sale of the services may be through a peer-to-peer (P2P) network facilitated by the GDS/PMS/OTA system 102. Once a customer purchases a service, the system will alert the customer of the ability to sell his or her service on the marketplace. If a customer decides to list his or her service, the service will be listed on the OTA 304 just as the services from travel providers appear.

In one example, airline tickets, hotel reservations, or event tickets may be sold out for a particular event. Customers willing to sell their services may do so on the marketplace.

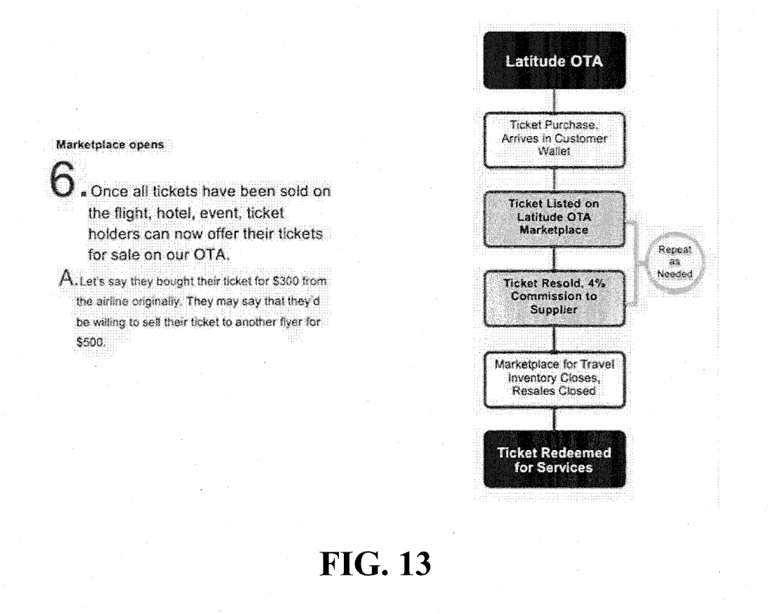

FIG. 13 shows step 612 the process 600, representing opening the marketplace for sale of travel services. For example, once all tickets for a flight, hotel, or event, ticket holders may sell their tickets directly to other customers using the marketplace functionality. By way of example, a customer may have purchased a ticket for $350 from an airline using the OTA 304. That same customer (now ticket holder) may sell the purchased ticket for a higher price on the marketplace. The re-sale price for the ticket may be chosen by the ticket owner, for example $500.

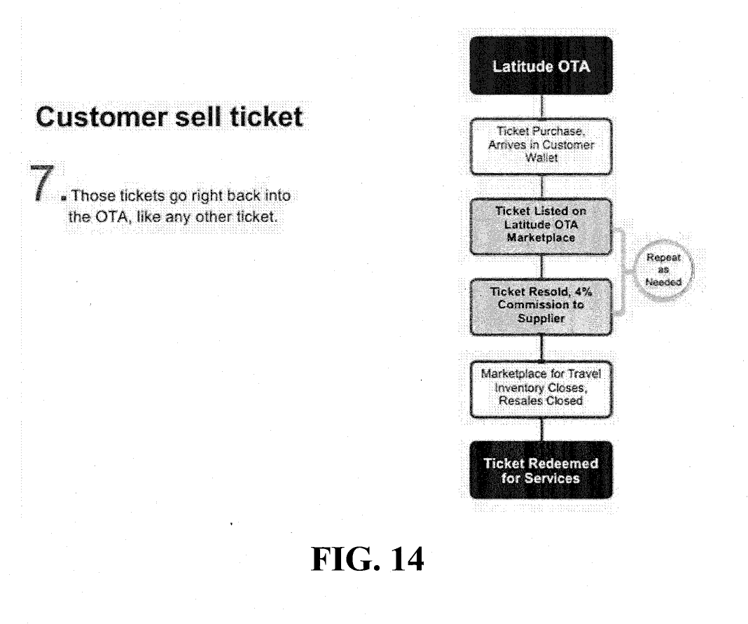

FIG. 14 shows step 614 the process 600, representing the sale of the ticket by a customer. When a customer (ticket holder) decides to sell his or her ticket, the ticket is placed in the OTA 304 platform like any other ticket that is for sale (e.g., by other customers, by travel providers, etc.).

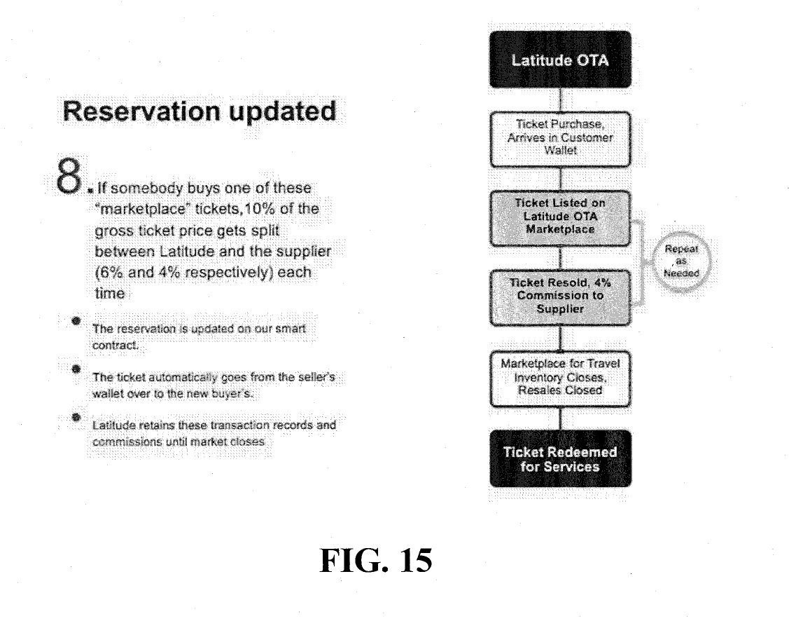

FIG. 15 shows step 616 of the process 600, representing the reservation update step. Upon a sale of a ticket on the marketplace, the currency is transferred from the customer to the ticket holder, and the ticket is transferred from the ticket holder to the new customer. The reservation is updated on the smart contract, and the ticket automatically transfers from the ticket holder's wallet to the customer's wallet.

By way of example, a commission may be charged for the re-sale of tickets on the marketplace platform. Commissions for the re-sale of services may be split between the owner of the system 102 and the travel supplier (e.g., 6% and 4%, respectively). Commissions may also be split in any other way using sound business judgment.

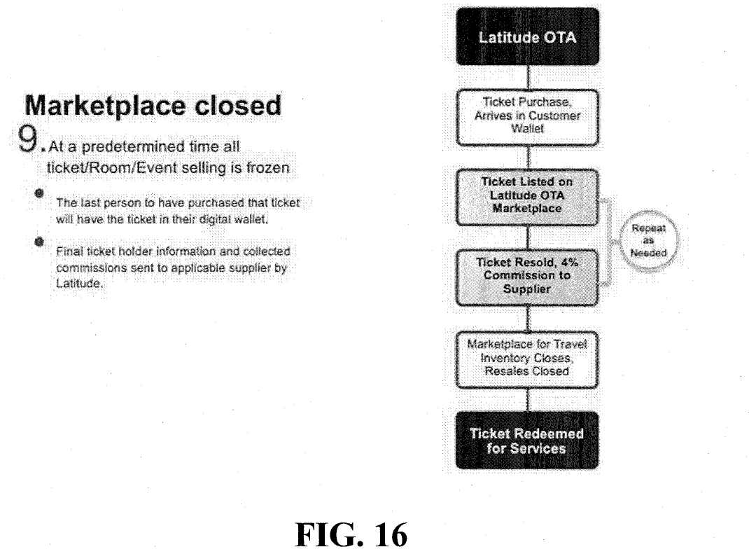

FIG. 16 shows step 618 of the process 600, representing the marketplace closing. At a predetermined time, the marketplace will close and will no longer be open for transactions. After the marketplace closes, the ticket(s) will remain with the last known ticket holder. The final ticket holder information and information on commission may be sent to the supplier at any given time. Sound business judgment may be used to determine when to close the marketplace and when to send final ticket data to the travel provider.

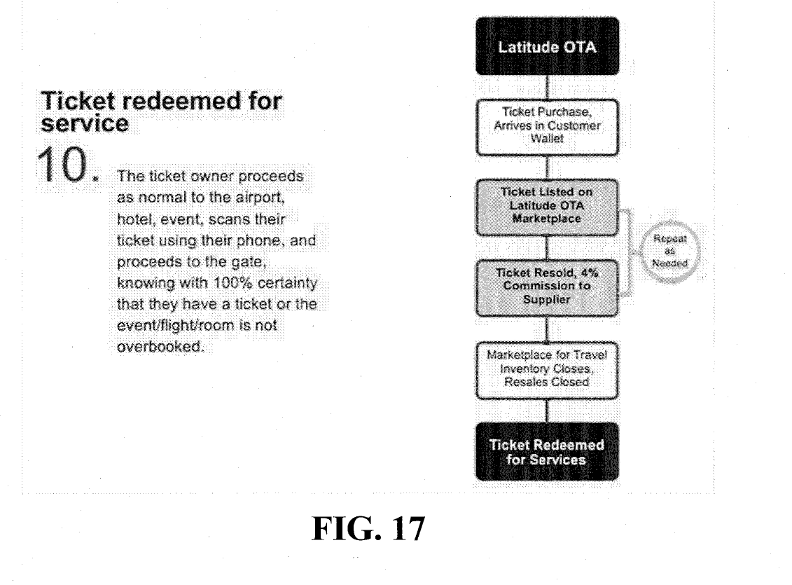

FIG. 17 shows the final step 620 of the process 600, related to the redemption of a ticket for service. In an example, a ticket holder may hold a ticket to a flight. To redeem the ticket, the ticket holder would proceed to the airport, scan the ticket at the gate using a cell phone, and proceed to the gate. Using the system 102 can guarantee that the seats on the flight have not been overbooked or oversold. Similar redemption procedures may occur for hotel reservations, rental car reservations, event tickets, etc.

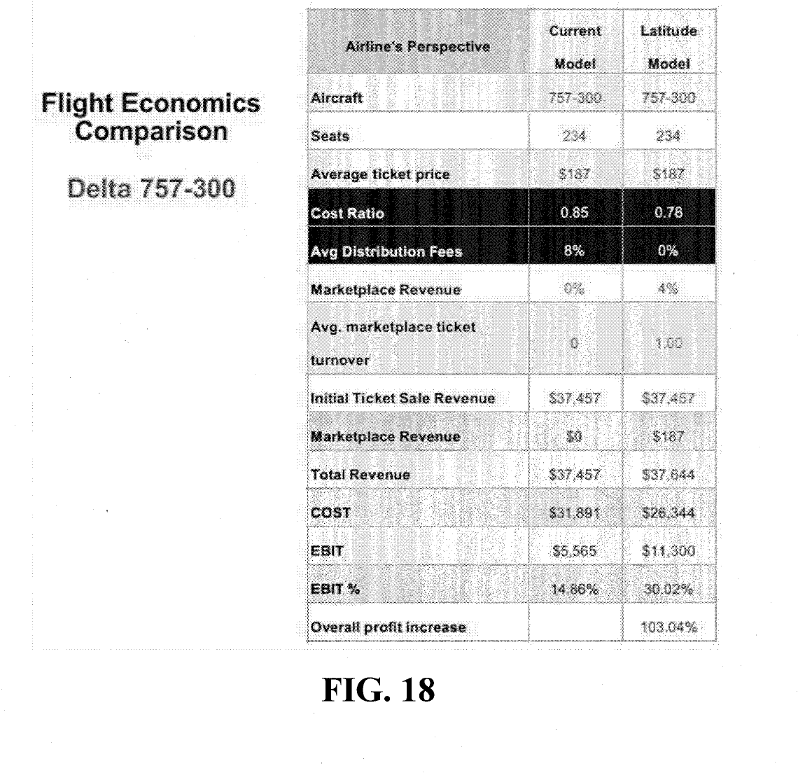

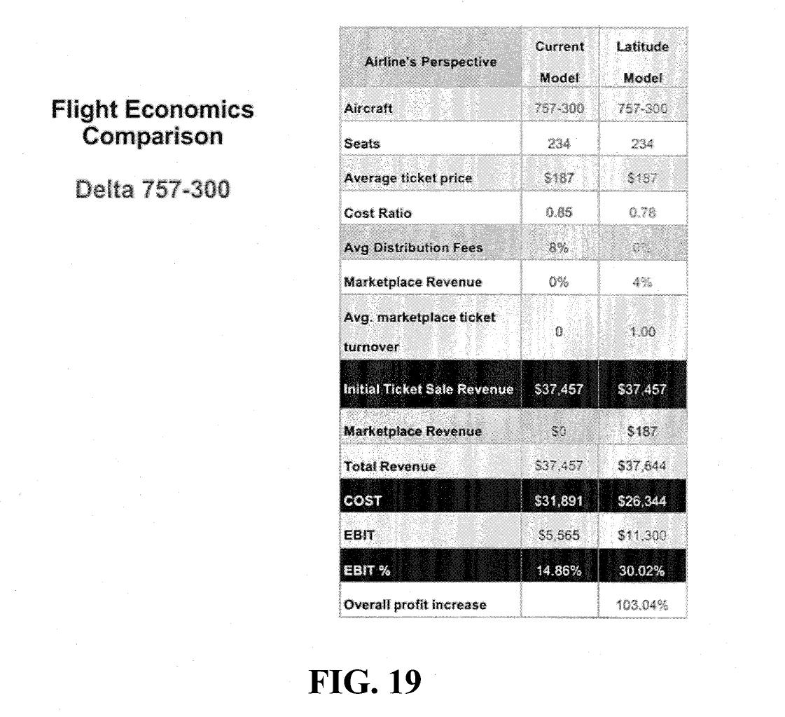

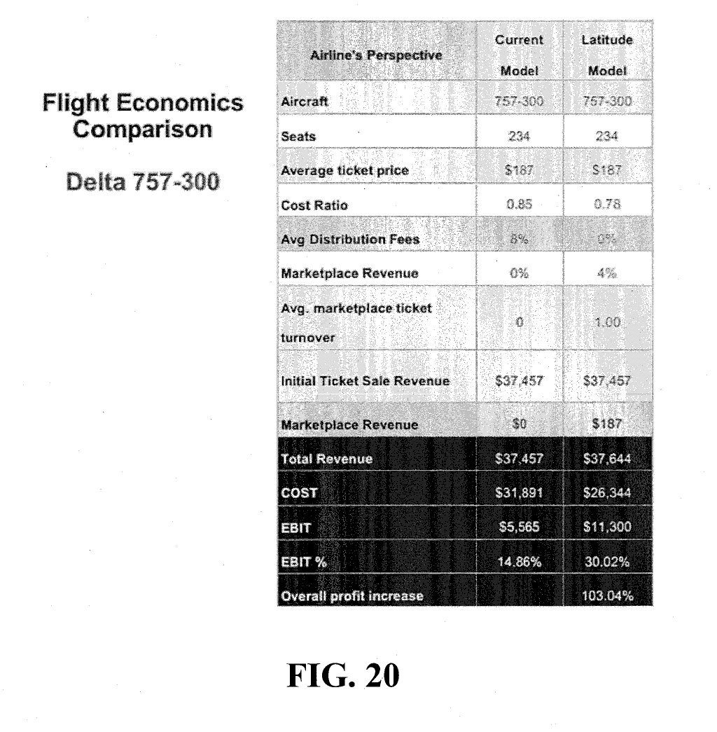

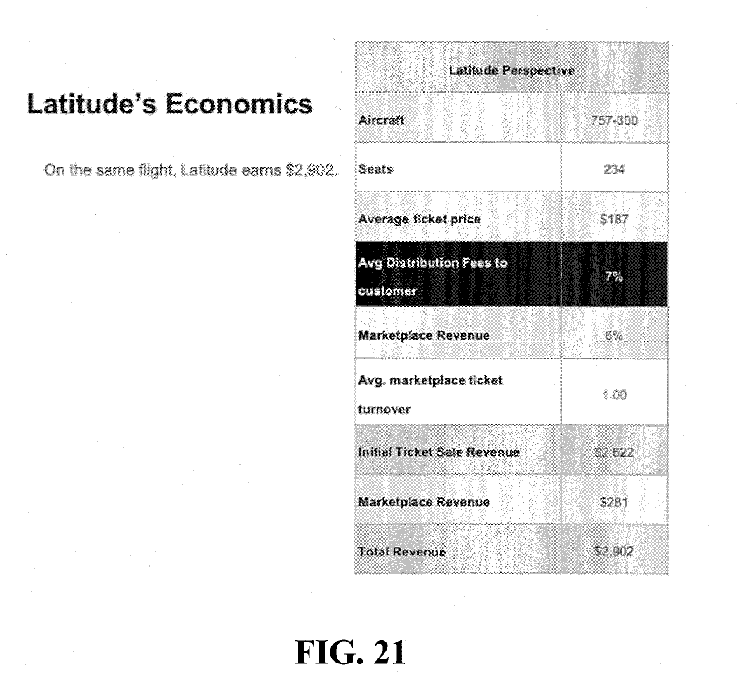

FIGS. 18-21 show an exemplary financial analysis for how the present innovative concept may provide cost effective solutions to travel service providers. The solution described in the present application may provide minimal or no distribution fee to travel providers. In a preferred embodiment, the average distribution fees for an airline, for example, will be 0%.

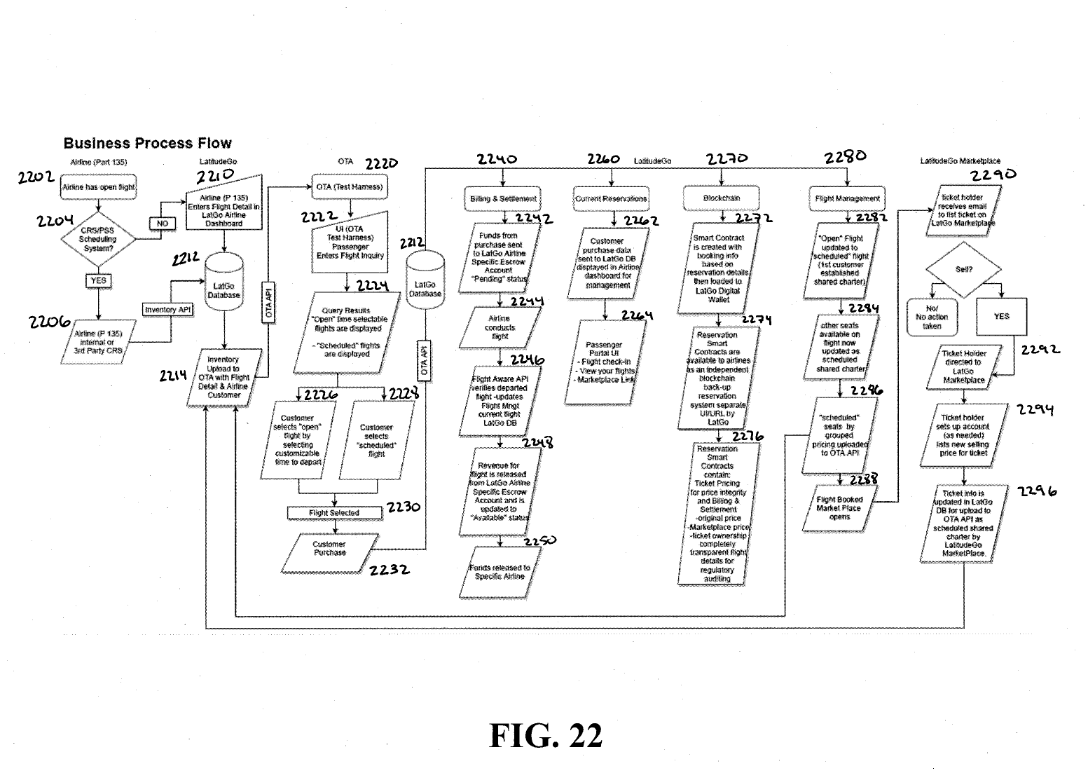

FIG. 22 shows an exemplary process flow chart 2200 for the methods described herein. The flow chart shows details on inventory searching, OTA transactions, marketplace transactions, and more. Starting with block 2202, an airline has at least one open seat on a flight. The inventory details of the flight may be uploaded to a database 2212 for the system 102 in multiple ways. A first method may include through a travel provider's third party computer reservation system (CRS) or passenger service system (PSS), shown in block 2206. A second method, shown in block 2210, requires a travel provider to enter inventory details directly into the system 102 via an airline dashboard. It should be recognized that inventory may be uploaded in any way to database 2212.

After the inventory information is uploaded to the database 2212, the inventory may be uploaded to an online travel agent (OTA) system 2220. Once the inventory is loaded into the OTA, a user may enter search queries via a user interface, as shown in block 2222. The search results from the user query are displayed as either “open” or “scheduled,” as shown in block 2224. Open flights are flights that have no schedule departure date or time. The user is free to select his or her preferred time of departure, as shown in block 2226. Flights that are already scheduled have a departure date and time, as shown in block 2228. The user is free to select this flight option, but may not select a new flight date or time as may be done for “open” flights.

The user may select a flight, as shown in block 2230. After selection, the user is free to purchase the flight using any number of interfaces, including the OTA interface 2220. The funds from the purchase (cryptocurrency, U.S. dollars, etc.) are sent to a specific escrow account and given a status of “pending,” as shown in block 2242.

In block 2244, the airline (or other travel provider) conducts the flight (or other service) as scheduled. Other services may include rental car reservations, hotel reservations, event tickets, and the like.

In block 2246, a service verifies the departed flight (or other service) and updates current flight information on the database 2212. The verification service may be a Flight Aware advanced passenger information (API) service for use with flight management, for example.

In block 2248, the funds described in block 2242 are released from the specific escrow account and the status is updated to “available.” After the funds are set to available, the funds may be released to the specific airline's virtual wallet, as shown in block 2250.

Current reservations 2260 may be managed through the system 102. The current reservations may be sent to the database 2212, and the travel provider may view the current reservations on a specialized dashboard for management. It should be appreciated that travel providers may also access reservation details through their own internal or third party CRS by accessing the database 2212.

Passengers may access a passenger portal, as shown in block 2264. Passengers may view current reservations, check in to flights, access the marketplace, and more. The passenger portal may be accessed from a cell phone or other similar device. A user interface will allow the user to navigate and access information from the database 2212.

Blockchain technology 2270 may be used to facilitate transactions as described herein. A smart contract may be created along with the transaction based on the reservation details, as described in block 2272. The smart contract can be loaded into a digital wallet associated with the system (e.g., LatitudeGo digital wallet, etc.). The reservation smart contracts are made available to travel providers as an independent Blockchain, as shown in block 2274.

A backup reservation system may also be provided using a separate UI/URL of the system 102. The backup system may be an offline CRS system that may be used if the main reservation system is down. A separate user interface portal may verify tickets and reservations at every airport to allow flights to continue operating as planned. This type of backup system does not exist at any airports today.

The reservation smart contracts contain specific details on the reservations and transactions, as described in block 2276. The smart contracts may include ticket pricing for integrity and billing purposes, original price, marketplace price, ownership details, flight details, and any other details, including but not limited to details for regulatory auditing.

Blocks 2280, 2282, 2284, and 2286 show an exemplary process in which a user may select an “open” flight 2226. When selecting an open flight and choosing flight details, the flight then becomes ‘scheduled” (i.e., when the first customer selects the open flight, chooses the date/time, and purchases the flight, the flight will become scheduled). When the flight becomes scheduled 2228, all other customers may select the flight without an option to choose a date or time, but they may still choose to purchase seat on the flight. The scheduled seats are uploaded to the OTA and API, and may be grouped by pricing details.

Blocks 2288, 2290, 2292, 2294, and 2296 show an exemplary process of completing a marketplace transaction between two customers. In the block 2288, the marketplace opens for a user following a purchase of a flight. The user/ticket holder receives a notification (e.g., by email, text message, phone call, etc.) that the ticket may be sold on the marketplace, as shown in block 2290. The ticket holder then makes a decision to sell or not to sell the ticket. If the ticket holder decides to sell the ticket, the ticket holder is directed to the marketplace, as described in block 2292.

The ticket holder creates an account associated with the marketplace (if needed) and lists the ticket for sale, as shown in block 2294. The ticket holder may choose a sale price for ticket (e.g., the ticket holder may choose a sale price at a greater price than the original purchase price to earn a profit). The updated ticket information is uploaded to the database 2212, and is accessible from the OTA API, as shown in block 2296. From there, other customers are free to search for and purchase the marketplace ticket.

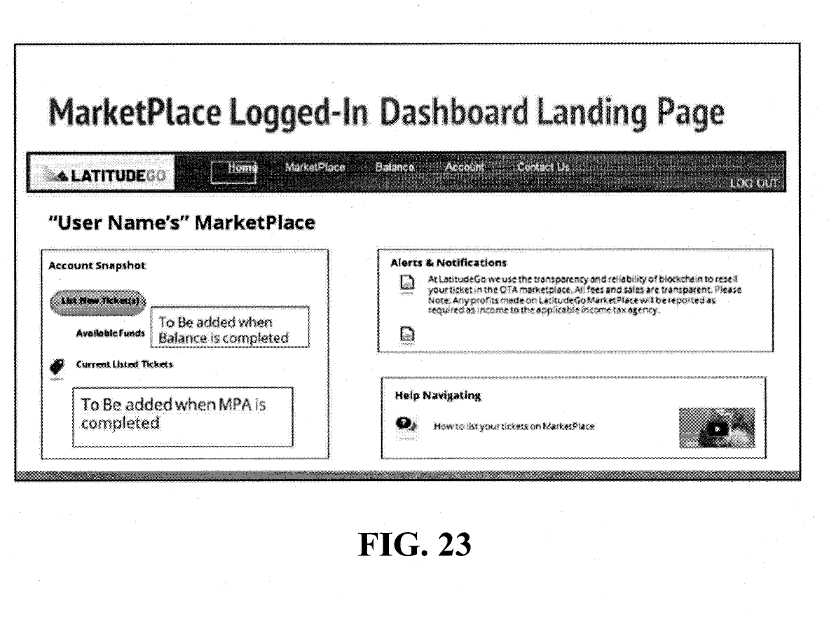

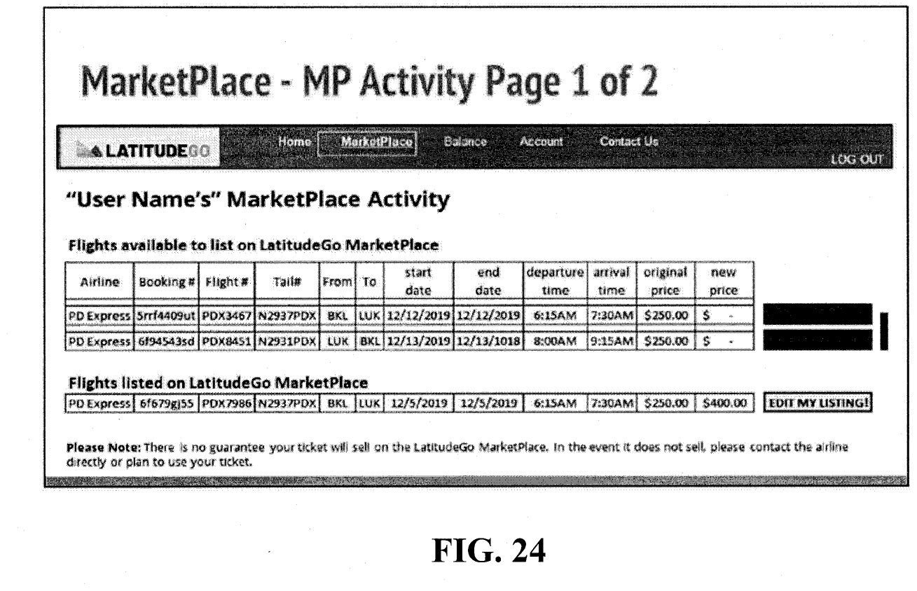

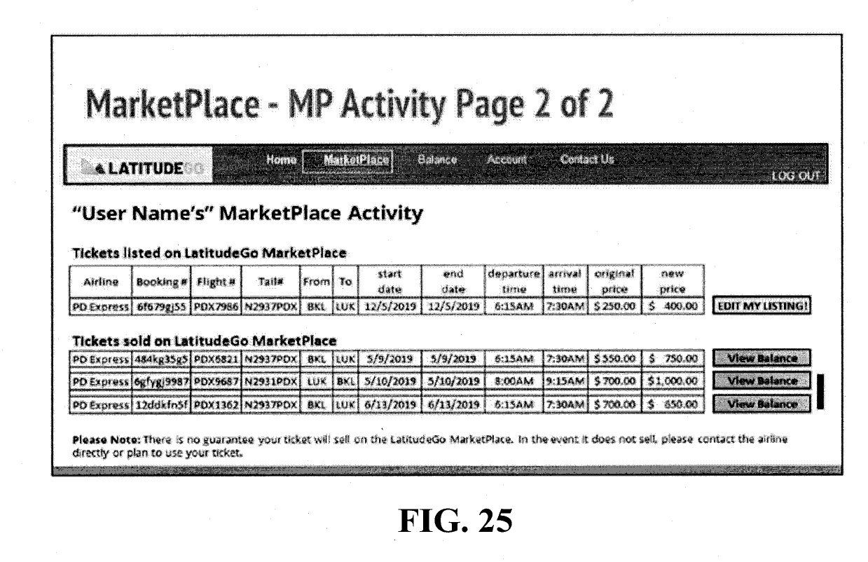

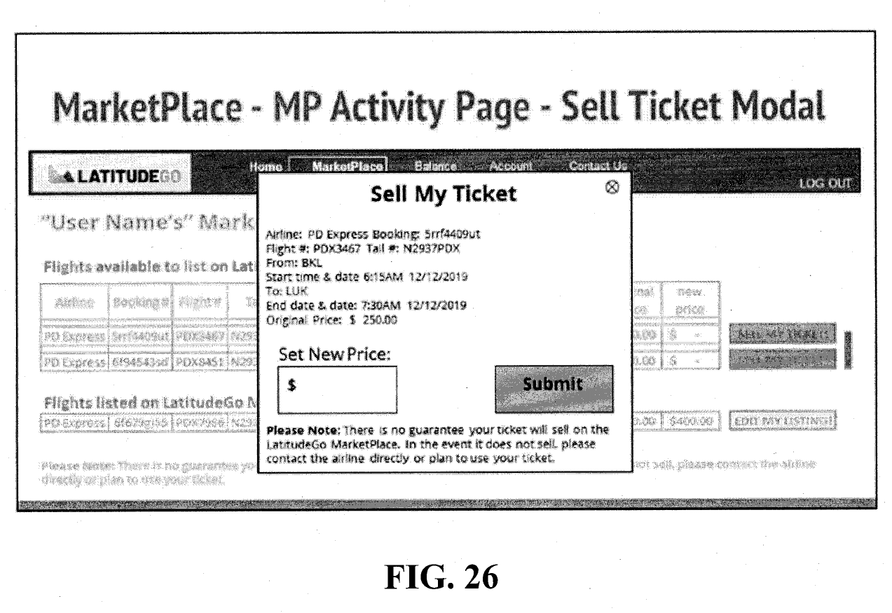

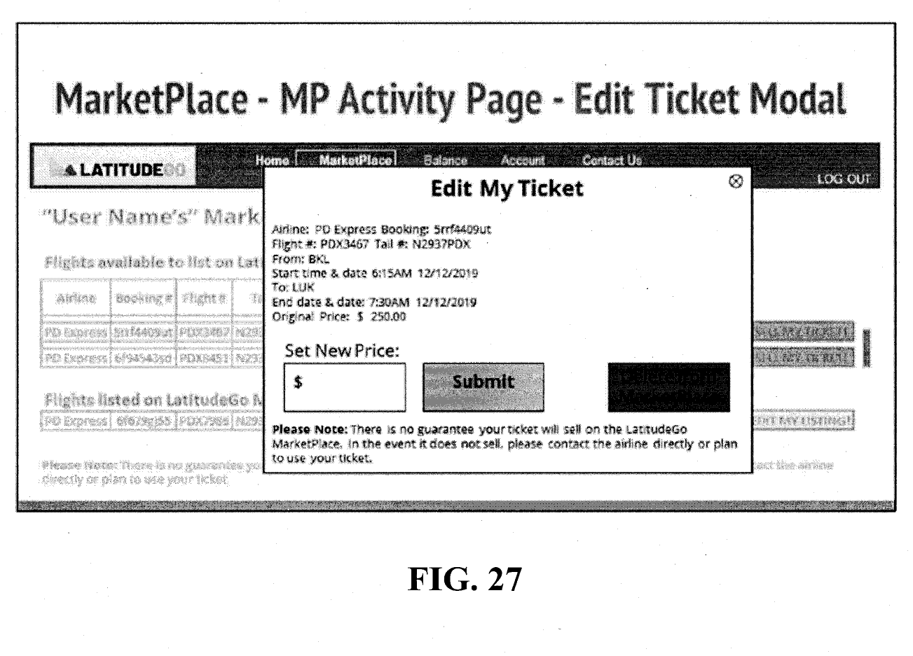

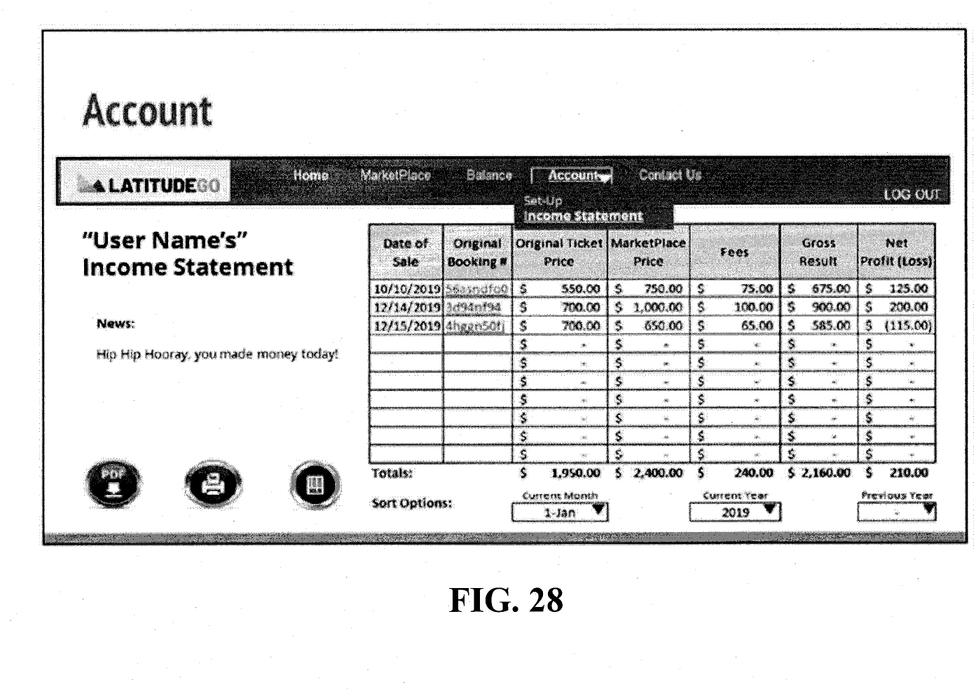

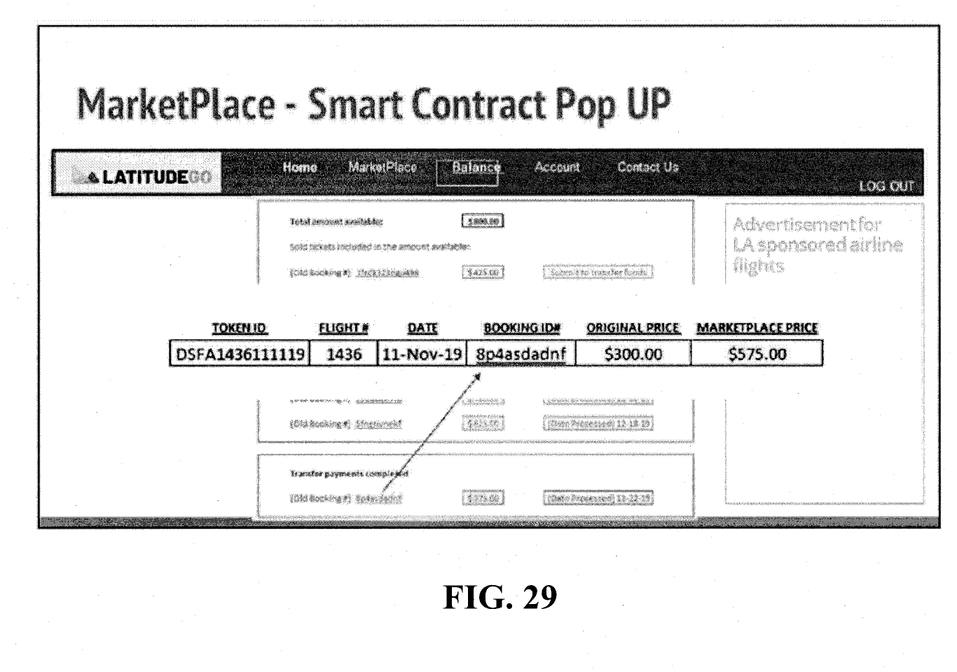

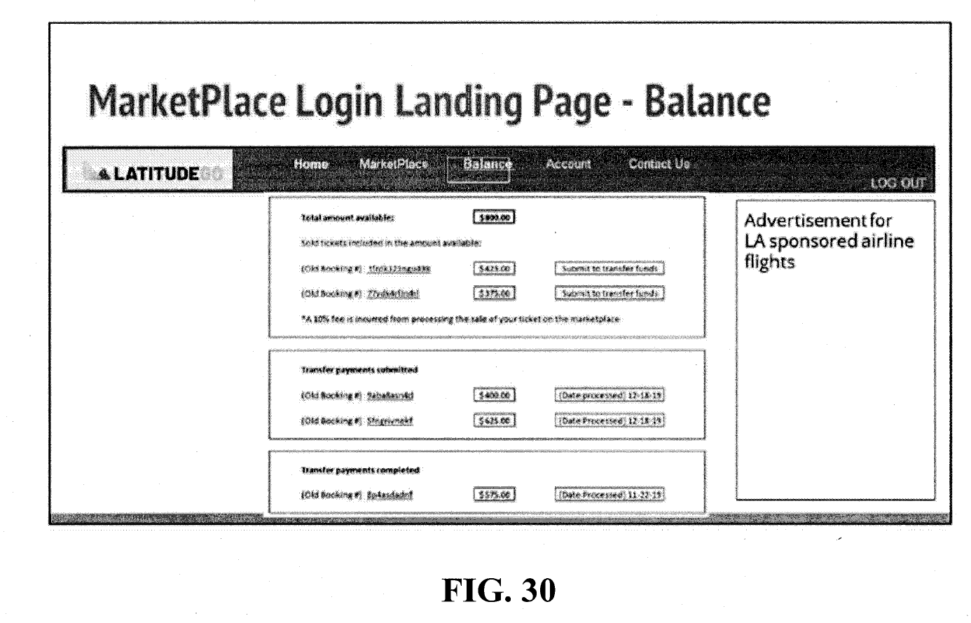

FIGS. 23-30 show an exemplary user interface for the marketplace platform described in the present application.

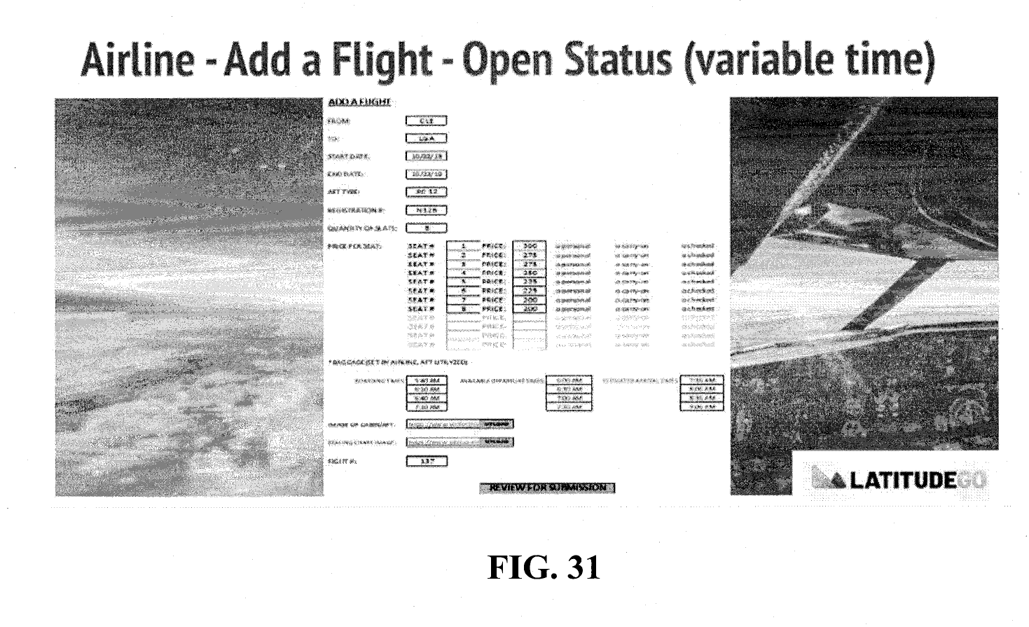

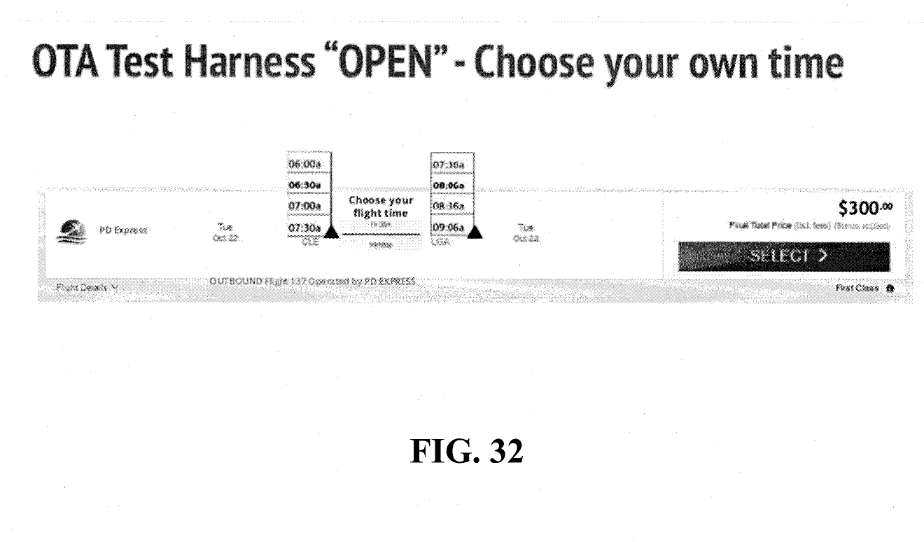

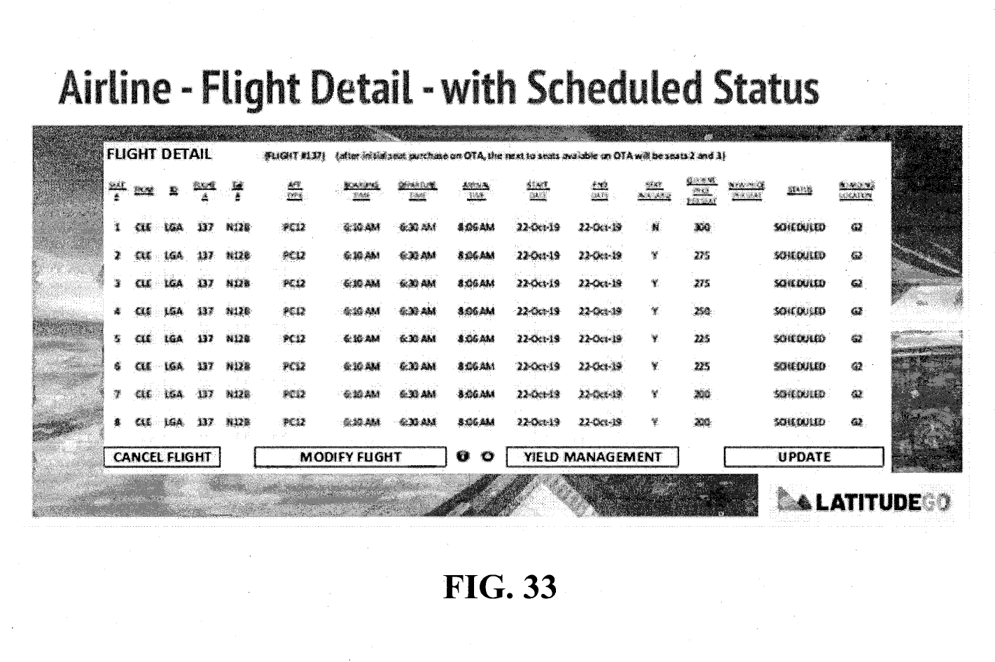

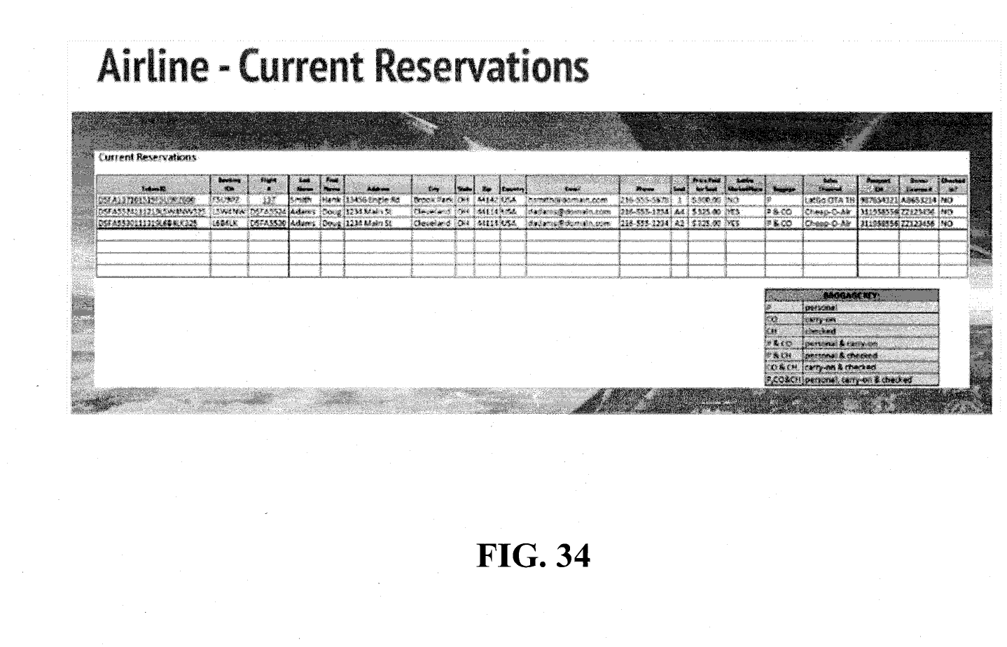

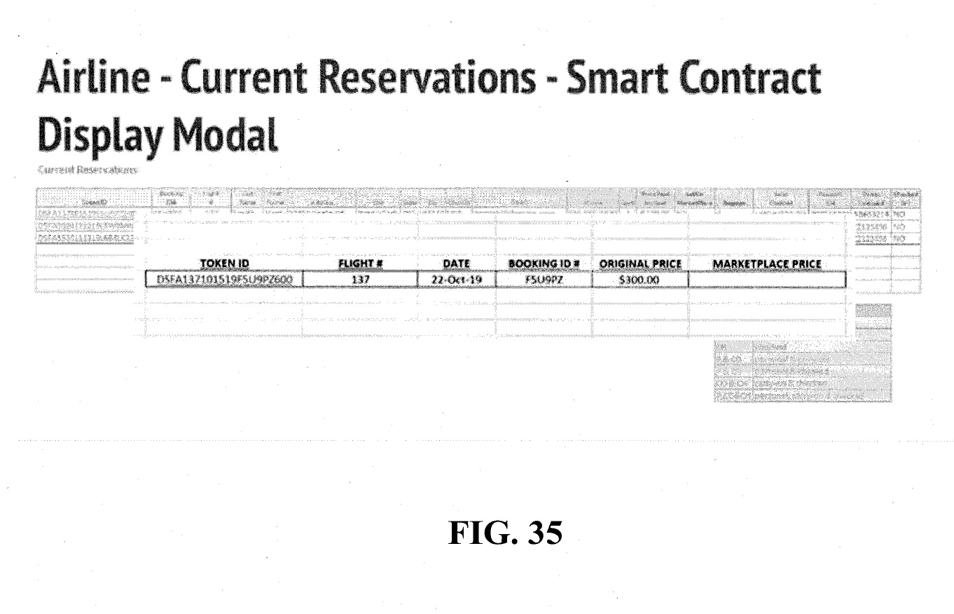

FIGS. 31-35 show an exemplary user interface GDS/OTA solution utilizing Blockchain technology as described in the present application.

The solution provided for in the present application may be used for any number of reservation items from airline ticket distribution, hotel room distribution, Cruise line cabin distribution, tours and activities, transfers, airport parking, trains and bus lines, car rentals, insurance, event ticketing, and similar items.

Approximately, 95% of travel market inventory distribution is controlled by GDS and PMS corporations including Sabre, Travelport, and Amadeus. These corporations control the supplier market including air carriers, cruise lines, hotels, and auto rentals and make it difficult for them, start-ups, and other small to mid-size suppliers to gain market share and make a profit. With our GDS/PMS/OTA solution, these suppliers to the travel industry and others that have been pushed out can now have open, affordable, access to the market.

Our intention is to disrupt the GDS/PMS/OTA industry by providing a free (to travel suppliers), open, decentralized cost savings solution that allows anyone to access inventory directly from the suppliers. A major pain in the travel industry is dealing with the intermediary companies, such as the online travel agencies, when help is needed. Going direct to the suppliers is vital to expedient resolution for which blockchain is not setup. LatitudeGO is a GDS company that uses a proprietary online platform to connect passengers with dynamically hailed flights using the revolutionary LatitudeGo Consolidator software and providing passengers with on-demand flight service globally.

At the onset, our system is intended for the B2B2C market demonstrated by commitments from suppliers and resellers to use our GDS/PMS/OTA. Targeting B2B will allow for market adoption and utilization. Our design and UI will allow both direct booking by customers familiar with blockchain as well as conventional booking to which the consumer market has become accustomed.

Driving this platform will be the Latitude coin, which will be configured to process the necessary travel industry functions and information within a transaction, as well as provide automatic billing settlement. This token will bring more capabilities for market needs, providing a competitive advantage as well as a P2P marketplace once a flight/hotel/event is booked. Further benefits include reduced transaction costs to both the national and international markets. We intend to keep the distribution direct vs. current GDS/PMS options.

The word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this innovative concept. It is intended to include all such modifications and alterations in so far as they come within the scope of the appended claims or the equivalents thereof.

What is claimed is:

1. A method for performing a transaction for a travel reservation, comprising:
selecting a travel reservation by performing a search of an online database via a user interface and queuing a list of results;
transferring a value of non-virtual currency from a customer into a first virtual wallet owned by the customer, wherein the first virtual wallet holds the value of the non-virtual currency as a virtual currency for a purchase of a travel reservation;
transferring the value of virtual currency from the first virtual wallet to a second virtual wallet, the second virtual wallet owned by a travel provider;
transferring the travel reservation from the second virtual wallet to the first virtual wallet; and
creating a smart contract associated with the transaction between the customer and the travel provider, wherein the smart contract is uploaded into the first or second virtual wallets.

2. The method of 1, wherein the virtual currency is transferred from the first virtual wallet to an escrow account, the virtual currency having a status identifier, the status identifier having a value, the value indicating that the virtual currency is not ready to be transferred to the second virtual wallet.

3. The method of claim 2, wherein an activity associated with the travel reservation changes the value of the status identifier, the value indicating that the virtual currency is ready to be transferred from the escrow account to the second virtual wallet.

4. The method of claim 1, wherein the customer may view information associated with the travel reservation from the first wallet.

5. The method of claim 1, wherein the smart contract is available on an offline and independent system, the system being accessible if the online database is not accessible.

6. The method of claim 1, wherein the virtual currency is a cryptocurrency.

7. The method of claim 1, wherein the non-virtual currency is paid using a credit card.

8. The method of claim 1, wherein the travel reservation is for an airline flight.

9. A method for managing customer to customer transactions, comprising:
opening a marketplace application to facilitate a sale of a travel reservation, wherein a first customer has possession of and decides to sell the travel reservation;
uploading information regarding the travel reservation into an online database, wherein the online database is in networked communication with the marketplace application;
allowing a second customer to perform a search of the online database using the marketplace application, wherein the search returns at least one travel reservation information, the at least one travel reservation information being associated with the travel reservation of the first customer;
allowing the second customer to complete a purchase of the travel reservation from the first customer using a virtual currency, wherein the purchase comprises transferring the virtual currency from the second customer to the first customer, transferring the travel reservation from the first customer to the second customer, creating a smart contract regarding the transfer of the virtual currency and the transfer of the travel reservation, updating the travel reservation on the smart contract, and updating the travel reservation on the online database; and
closing the marketplace from further transactions.

10. The method of claim 9, wherein the first customer sells the travel reservation to the second customer at a higher price than a purchase price by the first customer.

11. The method of claim 9, wherein the virtual currency is a cryptocurrency.

12. The method of claim 9, wherein the travel reservation is an airline flight.

13. A method for searching travel itineraries, comprising:
entering at least one itinerary to an online database, wherein the at least one itinerary represents at least one available seat on an airline flight;
uploading the at least one itinerary to an online travel agent system, wherein the online travel agent system includes a user interface platform;
searching the online database via the user interface platform; and
querying a list of results, wherein the list of results includes at the least one available seat on the airline flight, the available flight having a status of either open or scheduled, an open status represented an unscheduled flight result, and a scheduled status representing a scheduled flight result.

14. The method of claim 13, wherein the at least one itinerary includes at least one of a time, a date, and a location of the airline flight.

15. The method of claim 13, wherein a user may select a date and a time for an airline flight having a flight status of open.
